(19) United States
(12) Patent Application Publication
(10) Pub. No.: US 2012/0074258 A1
(43) Pub. Date: Mar. 29, 2012

(54) INTEGRATED AIRCRAFT INTERIOR

(75) Inventors: ROBERT PAPKE, CAMANO ISLAND, WA (US); ANDREW J. LUNDBERG, STANWOOD, WA (US); WILLIAM J. BANFIELD, LAKE STEVENS, WA (US)

(73) Assignee: BE INTELLECTUAL PROPERTY, INC., WELLINGTON, FL (US)

(21) Appl. No.: 13/239,294

(22) Filed: Sep. 21, 2011

Related U.S. Application Data
(60) Provisional application No. 61/385,954, filed on Sep. 23, 2010.

(51) Int. Cl. B64D 11/00

(52) U.S. Cl. 244/118.5

(57) ABSTRACT

An integrated aircraft interior module includes one or more ceiling panels, sidewall linings, decompression ventilation provisions, and overhead stowage compartments including cabin air distribution ducting, personal service units. The sidewall linings, overhead stowage compartments and other interior structure integrated items attach to existing aircraft structural provisions.

### CROSS-REFERENCES TO RELATED APPLICATIONS

This application is based upon and claims priority from U.S. Provisional Application No. 61/385,954, filed Sep. 23, 2010 incorporated by reference in its entirety.

### BACKGROUND

The present invention relates generally to aircraft interiors, and more particularly relates to a fully integrated commercial aircraft interior module including sidewall linings, decompression ventilation provisions, overhead stowage compartments, cabin air distribution ducting, personal service units (PSU) and ceilings, all configured to attach as an integrated interior module suitable for installation to existing aircraft structural supports, and suitable for retrofitting of commercial aircraft interiors.

Overhead stowage bins are currently generally shelf or fixed overhead stowage bins, pivot overhead stowage bins, or translating bins overhead stowage bins. The shelf or fixed bin is currently the most common design, having a door that typically opens outward and upward. Pivot and translating bin designs typically have a door that typically opens outward and downward at a controlled rate of opening, and provides good visibility during opening and closing.

Commercial aircraft interior sidewall linings, decompression ventilation provisions, overhead stowage compartments, cabin air distribution ducting, personal service units (PSU) and ceilings have traditionally been designed as individual components, with other functional components, such as air conditioning ducting components and lighting components secured to them by additional mounting brackets that, taken together for the entire aircraft, can contribute significant undesirable weight to the overall weight of the aircraft.

It would be desirable to provide a fully integrated commercial aircraft interior module that can be connected to existing aircraft structures to reduce the weight of such a fully integrated commercial aircraft interior module so as to contribute to overall aircraft weight reduction by elimination of secondary brackets, and to reduce installation time for retrofitting commercial aircraft interiors.

It would also be desirable to provide a fully integrated commercial aircraft interior module that can be retrofitted to existing aircraft support structures to provide increased structural capability of the commercial aircraft interior installation. The present invention meets these and other needs.

### SUMMARY OF THE INVENTION

Briefly, and in general terms, the present invention provides for an integrated aircraft interior “floor to floor” solution to the need for a fully integrated commercial aircraft interior module suitable for installation to existing aircraft structural supports, including the sidewall linings, decompression ventilation provisions, overhead stowage compartments (OHSC), cabin air distribution ducting, personal service units (PSU) and ceilings. These components are designed, fabricated, and fully pre-assembled to reduce the labor hours and parts required during installation process into the aircraft. The sidewall linings, overhead stowage compartments and other interior structure integrated items attach to existing aircraft structural provisions.

In one presently preferred embodiment, the present invention provides for a fully integrated commercial aircraft interior module, including the sidewall linings, decompression ventilation provisions, cabin air distribution ducting, personal service units (PSU) and ceilings, with overhead stowage compartments (OHSC) referred to as the “Fixed Bin” solution. In another presently preferred embodiment, the present invention provides for a fully integrated commercial aircraft interior module, including the sidewall linings, decompression ventilation provisions, cabin air distribution ducting, personal service units (PSU) and ceilings, with overhead stowage compartments (OHSC) referred to as the “Pivot Bin” solution. Both of these overhead stowage compartment solutions utilize the same design integration principles described above, and also utilize many of the same parts.

Accordingly, in a presently preferred aspect, the present invention provides for an integrated aircraft interior module for an interior cabin space of a passenger aircraft including existing aircraft structural provisions. The integrated aircraft interior module includes a right sidewall lining portion and a left sidewall lining portion, an overhead ceiling portion including at least one ceiling panel, a right side overhead stowage compartment connected between the right sidewall lining portion and the ceiling portion, and a left side overhead stowage compartment connected between the left sidewall lining portion and the ceiling portion, wherein the right and left sidewall lining portions, and the right and left overhead stowage compartments attach to the existing aircraft structural provisions. In a presently preferred aspect, one or more of the right and left sidewall lining portions include a decompression ventilation provision or vent, and one or more of the right and left sidewall lining portions include cabin air distribution ducting. In another presently preferred aspect, the right overhead stowage compartment includes one or more personal service units mounted beneath the right side overhead stowage compartment, and the left overhead stowage compartment includes one or more personal service units mounted beneath the left side overhead stowage compartment. In another presently preferred aspect, the right and left side overhead stowage compartments may be a pivot bin overhead stowage compartment or a fixed bin overhead stowage compartment.

These and other aspects and advantages of the invention will become apparent from the following detailed description and the accompanying drawings, which illustrate by way of example the features of the invention.

### BRIEF DESCRIPTION OF THE DRAWINGS

FIG. 1 is a schematic diagram of a cross-sectional view of a first embodiment of the integrated aircraft interior according to the invention.

FIG. 2 is a perspective view of the integrated aircraft interior of FIG. 1.

FIG. 3 is an enlarged perspective view of an overhead stowage compartment (OHSC) of the integrated aircraft interior of FIG. 1.

FIG. 4 is a top exterior perspective view of the integrated aircraft interior of FIG. 1.

FIG. 5 is an exterior perspective view of an overhead stowage compartment (OHSC) of the integrated aircraft interior of FIG. 1.

FIG. 6 is another exterior perspective view of the overhead stowage compartment (OHSC) of the integrated aircraft interior of FIG. 5.

FIG. 7 is a bottom exterior perspective view of the integrated aircraft interior of FIG. 1.

FIG. 8 is an exterior perspective view of an interior sidewall with integrated air distribution ducts, plenums, and decompression panels of the integrated aircraft interior of FIG. 1.

FIG. 9 is an elevational exterior view of the an interior sidewall of FIG. 8.

FIG. 10 is an interior perspective view of the an interior sidewall of FIG. 8.

FIG. 11 is a schematic diagram of a cross-sectional view of a second embodiment of the integrated aircraft interior according to the invention.

FIG. 12 is a front lower perspective view of a portion of the integrated aircraft interior of FIG. 11.

FIG. 13 is a top exterior perspective view of the integrated aircraft interior of FIG. 11.

FIG. 14 is a top exterior perspective view of an overhead stowage compartment (OHSC) of the integrated aircraft interior of FIG. 11.

FIG. 15 is a bottom exterior perspective view of the overhead stowage compartment (OHSC) of the integrated aircraft interior of FIG. 11.

FIG. 16 is an exterior perspective view of an interior sidewall with integrated air distribution ducts, plenums, and decompression panels of the integrated aircraft interior of FIG. 11.

FIG. 17 is an elevational exterior view of the an interior sidewall of FIG. 16.

### DETAILED DESCRIPTION OF THE PREFERRED EMBODIMENTS

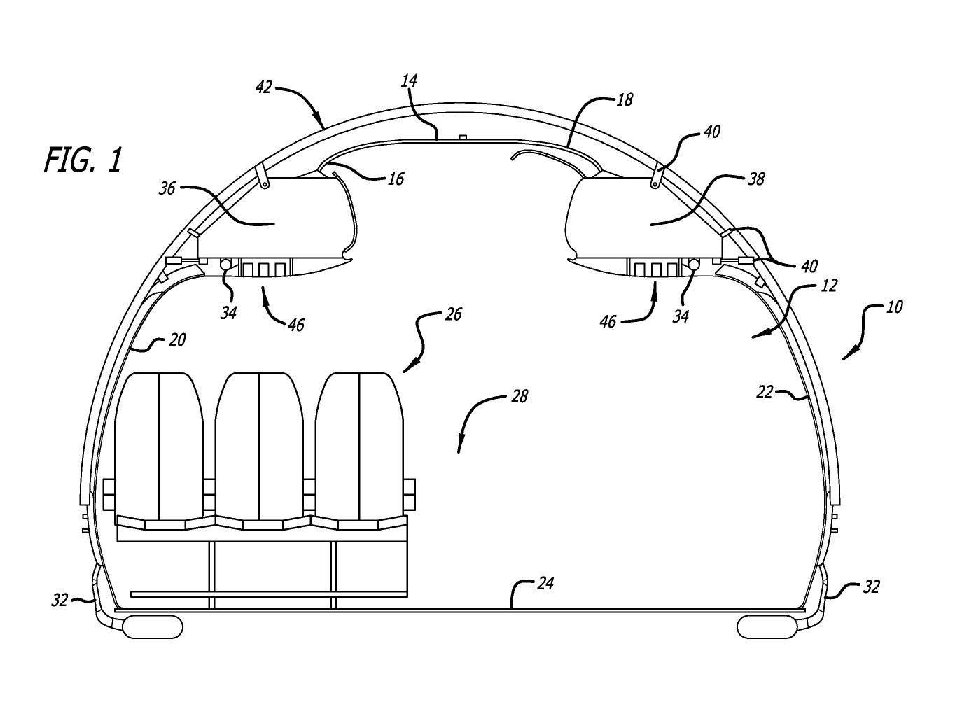

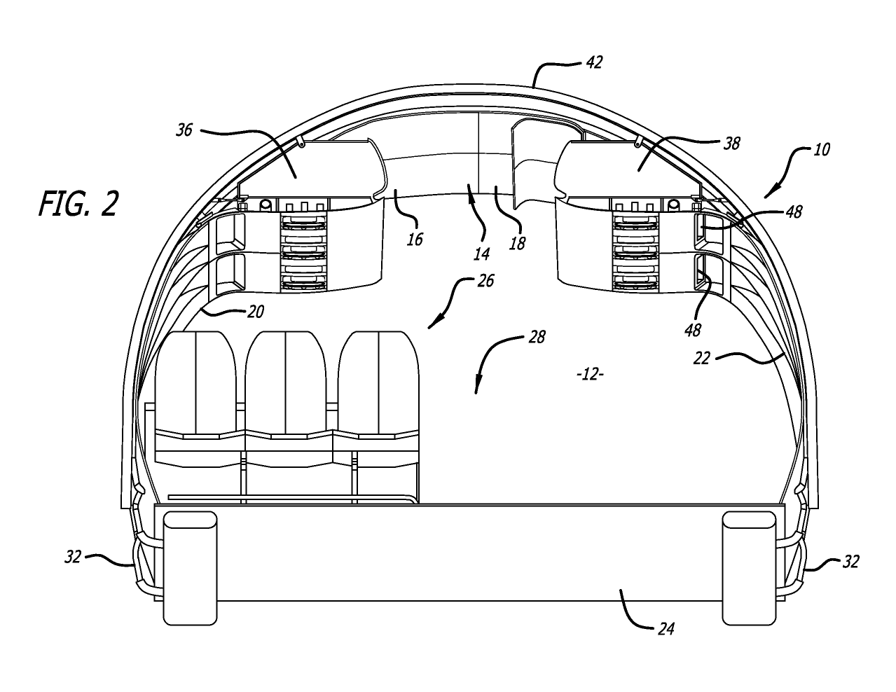

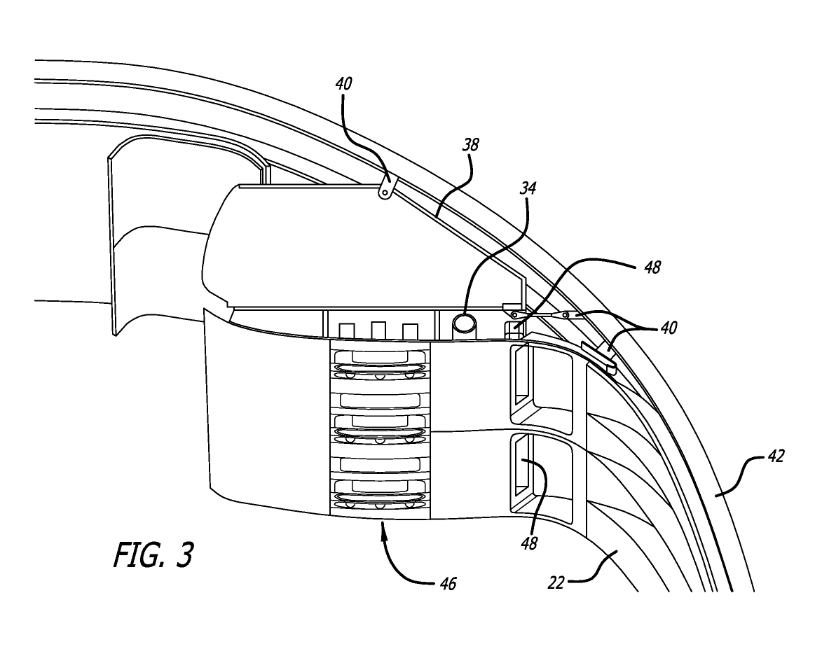

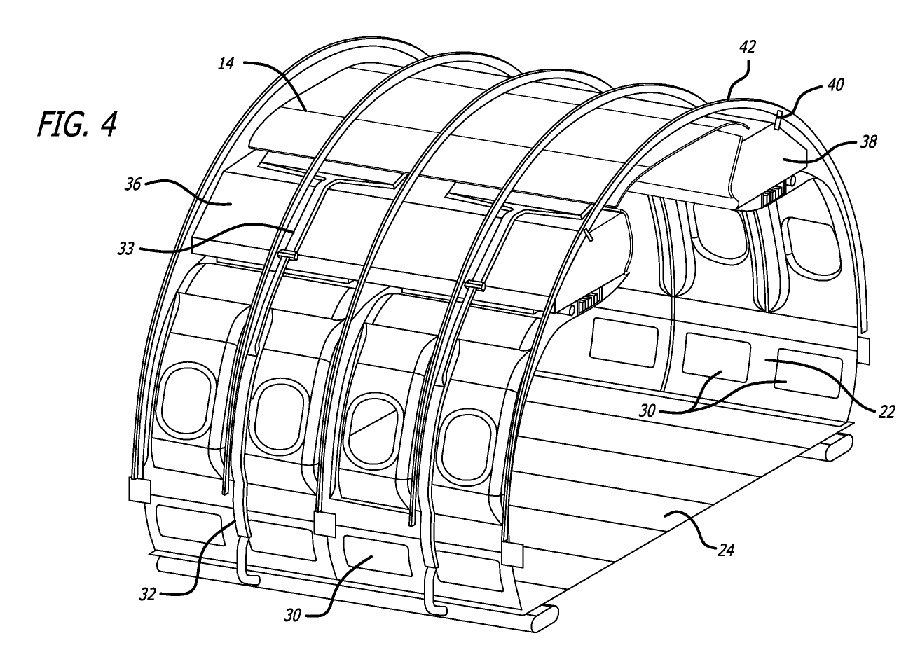

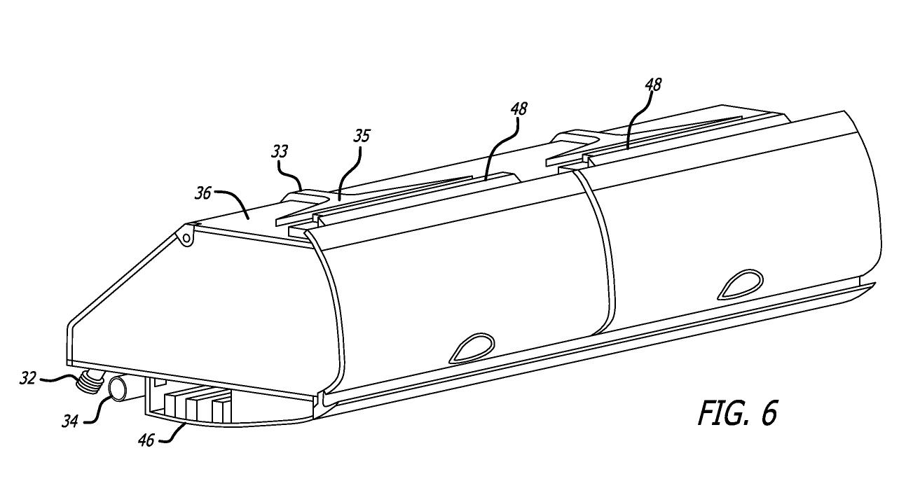

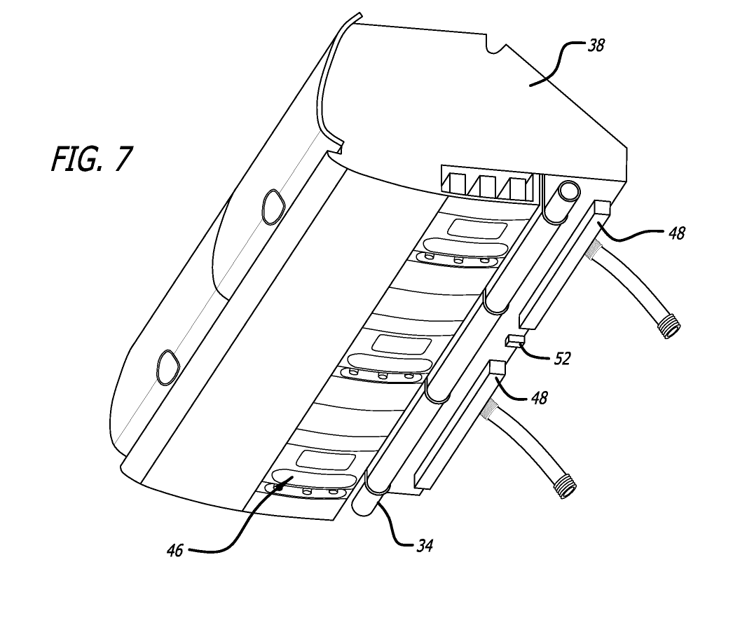

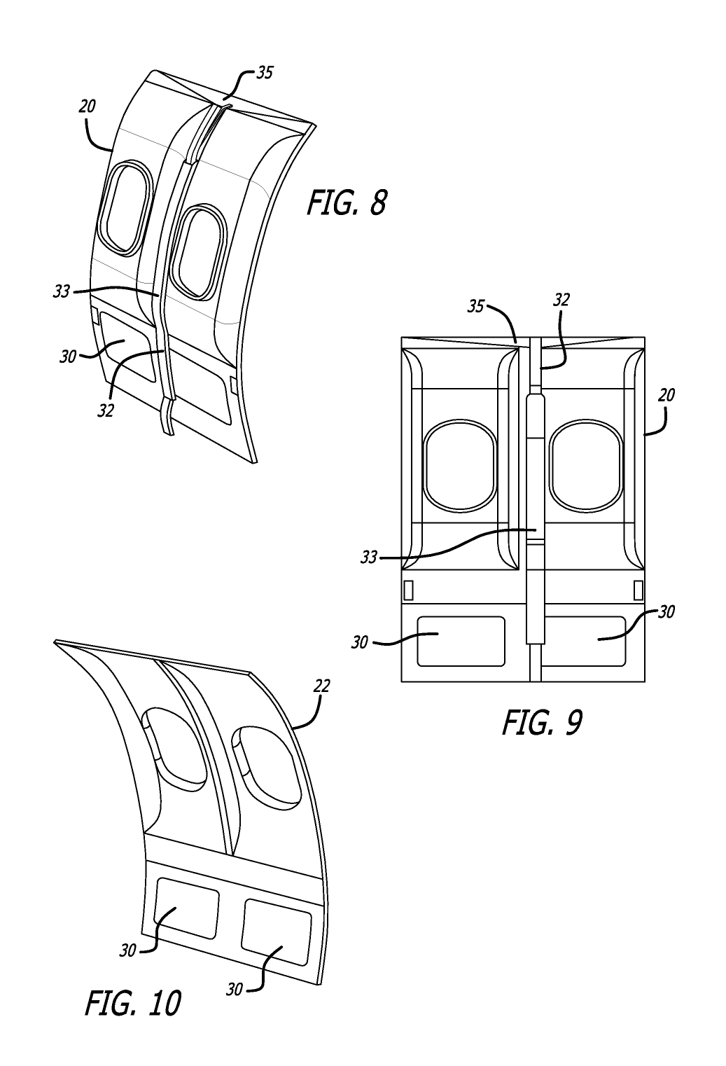

Referring to FIGS. 1-10, in a first embodiment, the present invention provides for a “floor to floor” integrated aircraft interior module 10 for an interior cabin area 12 of a passenger aircraft (not shown). As is illustrated in FIGS. 1 and 2, the aircraft passenger cabin area typically includes an overhead ceiling portion 14 including at least one ceiling panel, with a first or right side 16 and a second or left side 18, a first or right sidewall lining portion 20, a second or left sidewall lining portion 22, and a floor 24 with at least one set of passenger seats 26, and typically an aisle 28 between first and second sets of passenger seats. The sidewall lining portions each preferably also include one or more decompression ventilation panels or vents 30, and cabin air distribution ducting 32, including risers 33 and plenums 35, connected to gasper air distribution ducting 34 for ventilation in the interior cabin area, as is illustrated in FIGS. 3-10.

The aircraft passenger cabin typically also includes a first or right side overhead stowage bin or compartment 36 generally in the first or right side of the ceiling area, connected between the right sidewall lining portion and the ceiling portion, and a second or left side overhead stowage bin or compartment 38 generally in the second side of the ceiling area, connected between the left sidewall lining portion and the ceiling portion. The opposing right and left sidewall linings, overhead stowage bins or compartments, cabin air distribution ducting, and other similar interior structure integrated items preferably attach to existing aircraft structural frame provisions 40 for attachment to an aircraft frame 42. The overhead stowage bins or compartments may be shelf or fixed bin type overhead stowage compartments, as is illustrated in FIGS. 1-7. In a presently preferred aspect, one or more personal service units (PSU) 46 are preferably mounted beneath one or both of the right and left side overhead stowage bins or compartments. The integrated aircraft interior module also preferably includes one or more covered washlights 48, which may be mounted to an upper portion of the sidewall lining portions and on the overhead stowage bins or compartments near the ceiling portion.

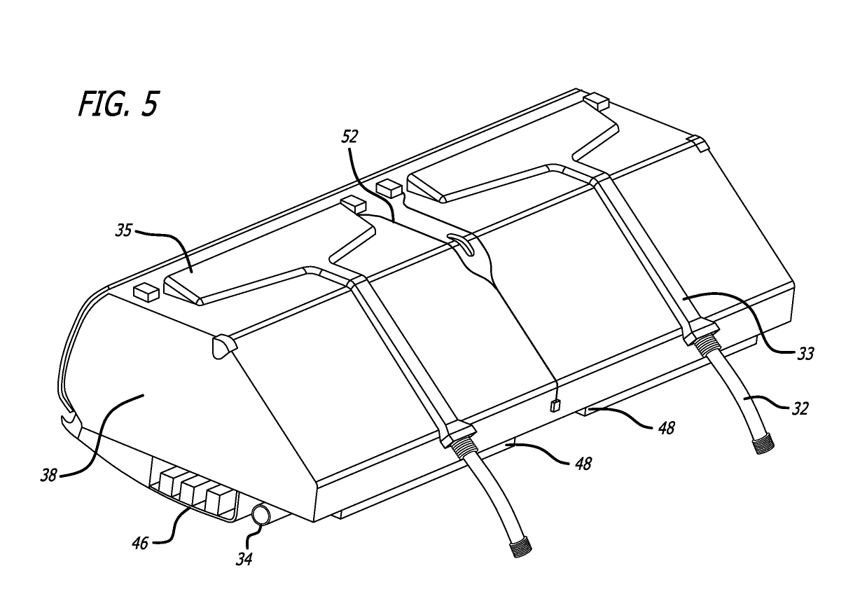

All of these components are designed, fabricated, and fully pre-assembled to reduce the labor hours and parts required during the installation process into the aircraft, and attach to existing aircraft structural provisions. The sidewall linings with the integrated items also attach and interface with existing aircraft structural provisions. As is illustrated in FIGS. 5 and 7, the “Fixed Bin” overhead stowage compartments (OHSC) also include integrated electrical wiring 52 that connects to electrically powered components.

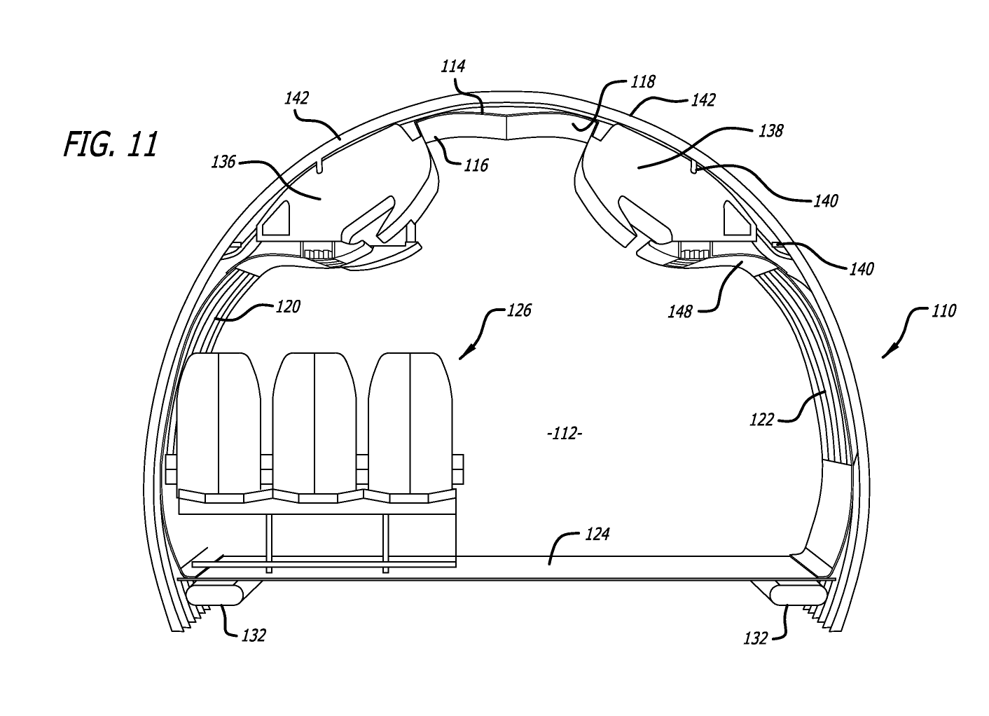

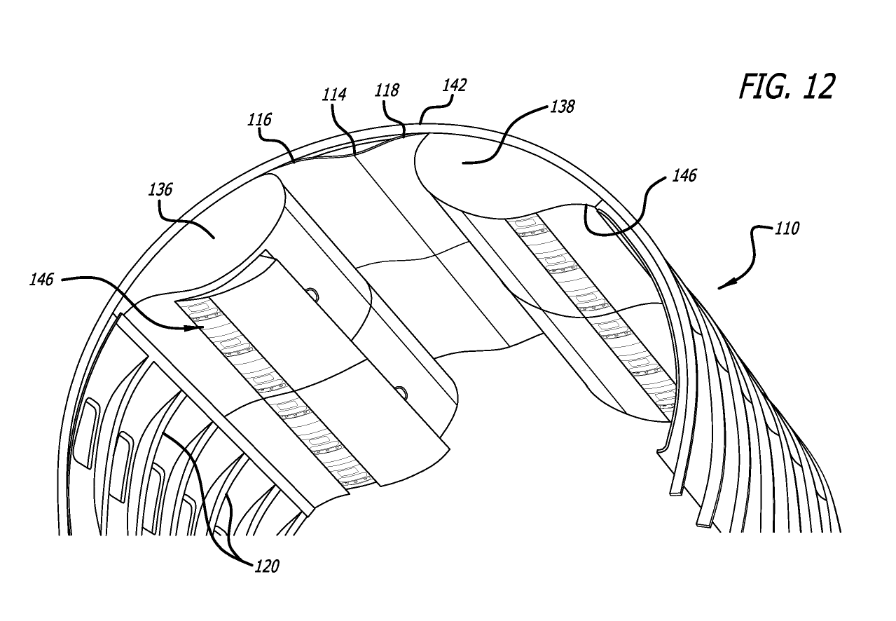

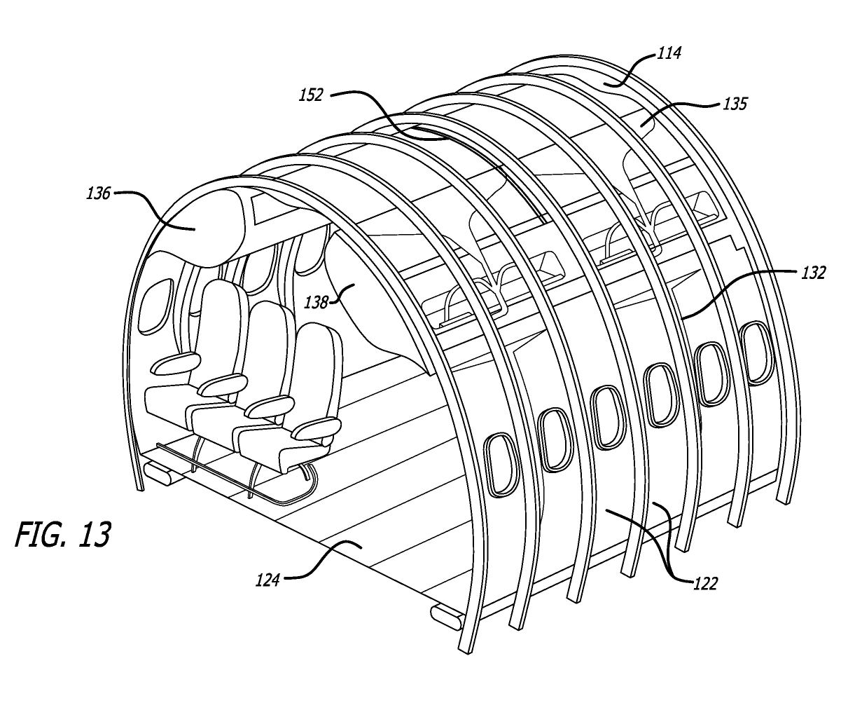

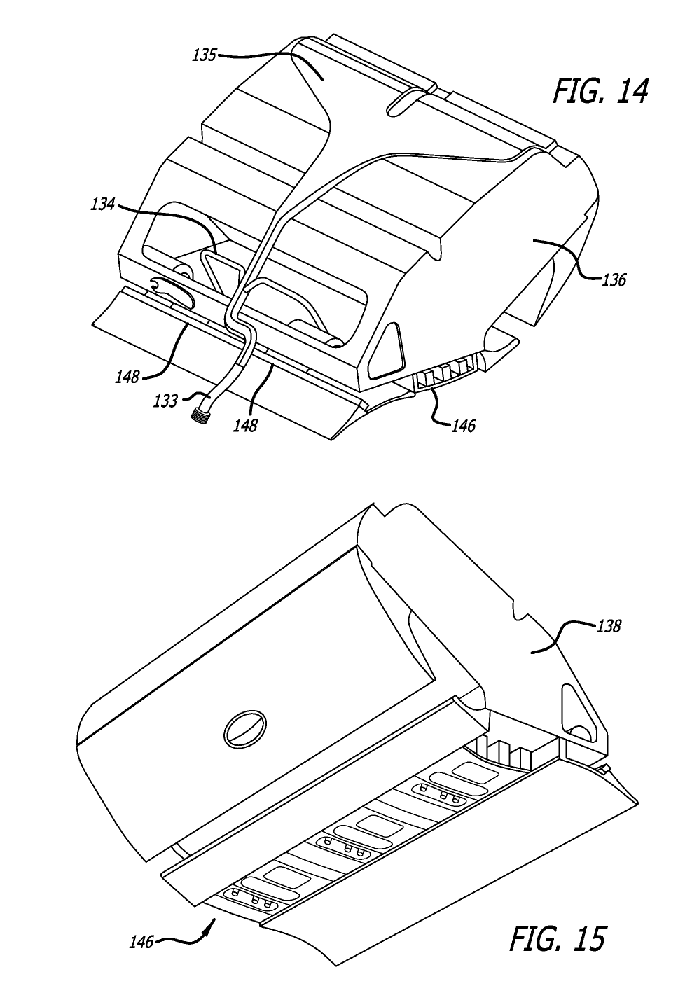

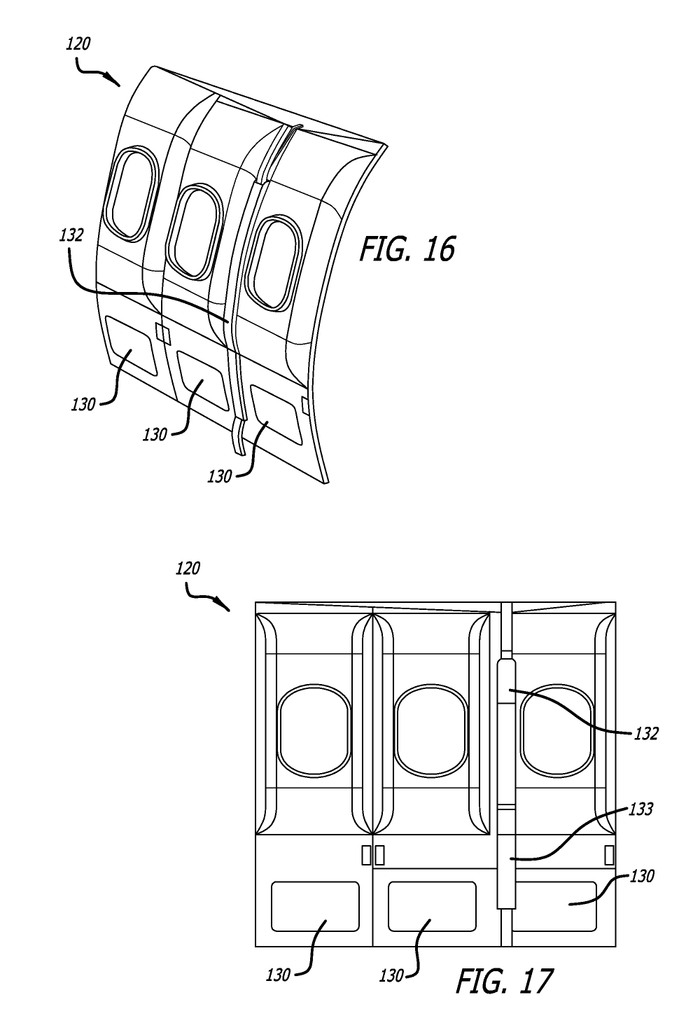

Referring to FIGS. 11-17, in a second embodiment, the present invention provides for a “floor to floor” integrated aircraft interior module 110 for an aircraft passenger cabin area 112 of a passenger aircraft (not shown). As is illustrated in FIGS. 11 and 13, the aircraft passenger cabin area typically includes an overhead ceiling portion 114 including at least one ceiling panel, with a first or right side 116 and a second or left side 118, a first or right sidewall lining portion 120, a second or left sidewall lining portion 122, and a floor 124 with at least one set of passenger seats 126, and typically an aisle 128 between first and second sets of passenger seats. One or both of the sidewall lining portions preferably also include one or more decompression ventilation panels or vents 130, and cabin air distribution ducting 132, including risers 133 and plenums 135, connected to gasper air distribution ducts 134 for ventilation in the interior cabin area, as illustrated in FIGS. 13, 14, 16 and 17.

The aircraft passenger cabin typically also includes a first or right side overhead stowage bin or compartment 136 generally in the first or right side of the ceiling area, connected between the right sidewall lining portion and the ceiling portion, and a second or left side overhead stowage bin or compartment 138 generally in the second side of the ceiling area, connected between the left sidewall lining portion and the ceiling portion. The opposing right and left sidewall linings, overhead stowage bins or compartments, cabin air distribution ducting, and other similar interior structure integrated items preferably attach to existing aircraft structural frame provisions 140 for attachment to the aircraft frame 142. The overhead stowage bins or compartments may be pivot type overhead stowage bins or compartments, as is illustrated in FIGS. 11-15.

In a presently preferred aspect, one or more personal service units (PSU) 146 are preferably mounted beneath one or both of the right and left overhead stowage bins or compartments. The integrated aircraft interior module also preferably includes covered washlights 148, which may be mounted to an upper portion of the sidewall lining portions and on the overhead stowage bins or compartments near the ceiling portion.

All of these components are designed, fabricated, and fully pre-assembled to reduce the labor hours and parts required during the installation process into the aircraft, and attach to existing aircraft structural provisions. The sidewall linings with the integrated items also attach and interface with existing aircraft structural provisions. As is illustrated in FIG. 13, the “Pivot Bin” overhead stowage compartments (OHSC) also includes integrated electrical wiring 152 that connects to electrically powered components.

Both of these overhead stowage compartment solutions described above utilize the same design integration principles described above, and also utilize many of the same parts. The individual components that comprise the overall aircraft interior are provided as a complete product kit. This results in a reduction of labor hours required during installation by providing pre-assembled elements that require fewer procedures and parts required to complete the installation of the aircraft interior. The overhead stowage compartments (OHSC) come pre-installed with integrated lighting, electrical connection interfaces, PSU panels and integrated air distribution. This alleviates the need to install separate lighting, air distribution ducts/plenums/provisions and PSU panels. Sidewall linings come with integrated air distribution and integrated decompression panels. This alleviates the need to install air distribution ducts/plenums/attachment hardware and also alleviates the need to separately install the decompression (Dado) panels.

The integrated aircraft interior of the present invention provides for increased OHSC volume and capacity, overhead lighting that shines on open OHSC doors when the doors are in an open position, and pre-installed integrated lighting, Personal service units, air distribution and electrical wiring. The integrated aircraft interior of the present invention will reduce the labor hours and parts required for installation of aircraft interior products; and since air distribution riser ducts and related attachment parts no longer need to be installed and attached to the frames of the aircraft during the installation process, and PSU panels no longer need to be installed into the OHSC during the installation process, the time and parts required for installation will be further reduced.

It will be apparent from the foregoing that while particular forms of the invention have been illustrated and described, various modifications can be made without departing from the spirit and scope of the invention.

We claim:

1. An integrated aircraft interior module for an interior cabin space of a passenger aircraft including existing aircraft structural provisions, the integrated aircraft interior module comprising:
a right sidewall lining portion and a left sidewall lining portion;
an overhead ceiling portion including at least one ceiling panel;
a right side overhead stowage compartment connected between said right sidewall lining portion and said ceiling portion; and
a left side overhead stowage compartment connected between said left sidewall lining portion and said ceiling portion, wherein said right and left sidewall lining portions, and said right and left overhead stowage compartments attach to existing aircraft structural provisions.

2. The integrated aircraft interior module of claim 1, wherein said right sidewall lining portion comprises a decompression ventilation provision.

3. The integrated aircraft interior module of claim 1, wherein said right sidewall lining portion comprises cabin air distribution ducting.

4. The integrated aircraft interior module of claim 1, wherein said left sidewall lining portion comprises a decompression ventilation provision.

5. The integrated aircraft interior module of claim 1, wherein said left sidewall lining portion comprises cabin air distribution ducting.

6. The integrated aircraft interior module of claim 1, wherein said right overhead stowage compartment comprises at least one personal service unit mounted beneath said right side overhead stowage compartment.

7. The integrated aircraft interior module of claim 1, wherein said left overhead stowage compartment comprises at least one personal service unit mounted beneath said left side overhead stowage compartment.

8. The integrated aircraft interior module of claim 1, wherein said right side overhead stowage compartment comprises a pivot bin overhead stowage compartment.

9. The integrated aircraft interior module of claim 1, wherein said left side overhead stowage compartment comprises a pivot bin overhead stowage compartment.

10. The integrated aircraft interior module of claim 1, wherein said right side overhead stowage compartment comprises a fixed overhead stowage compartment.

11. The integrated aircraft interior module of claim 1, wherein said left side overhead stowage compartment comprises a fixed overhead stowage compartment.

12. The integrated aircraft interior module of claim 1, further comprising at least one element selected from the group consisting of a decompression vent provided in at least one of said right sidewall lining portion and said left sidewall lining portion; cabin air distribution ducting provided in at least one of said right sidewall lining portion and said left sidewall lining portion; a personal service unit mounted beneath at least one of said right side overhead stowage compartment and said left side overhead stowage compartment; a covered washlight mounted to an upper portion of at least one of said right sidewall lining portion, said left sidewall lining portion, said right side overhead stowage compartment and said left side overhead stowage compartment; integrated electrical wiring that connects to electrically powered components; and combinations thereof.

13. An integrated aircraft interior module for an interior cabin space of a passenger aircraft including existing aircraft structural provisions, the integrated aircraft interior module comprising:
a right sidewall lining portion and a left sidewall lining portion, at least one of said right and left sidewall lining portions including a decompression vent, and at least one of said right and left sidewall lining portions including cabin air distribution ducting;
an overhead ceiling portion including at least one ceiling panel;
a right side overhead stowage compartment connected between said right sidewall lining portion and said ceiling portion; and
a left side overhead stowage compartment connected between said left sidewall lining portion and said ceiling portion, and wherein said right and left sidewall lining portions, and said right and left overhead stowage compartments attach to existing aircraft structural provisions.

14. The integrated aircraft interior module of claim 13, wherein said right and left side overhead stowage compartments each comprise pivot bin overhead stowage compartments.

15. The integrated aircraft interior module of claim 13, wherein said right and left side overhead stowage compartments each comprise a fixed overhead stowage compartment.

16. The integrated aircraft interior module of claim 13, further comprising a personal service unit mounted beneath at least one of said right side overhead stowage compartment and said left side overhead stowage compartment.

17. The integrated aircraft interior module of claim 16, wherein said right side overhead stowage compartment includes a plurality of personal service units mounted beneath said right side overhead stowage compartment.

18. The integrated aircraft interior module of claim 16, wherein said left side overhead stowage compartment includes a plurality of personal service units mounted beneath said left side overhead stowage compartment.

19. The integrated aircraft interior module of claim 13, further comprising at least one element selected from the group consisting of a covered washlight mounted to an upper portion of at least one of said right sidewall lining portion, said left sidewall lining portion, said right side overhead stowage compartment and said left side overhead stowage compartment; integrated electrical wiring that connects to electrically powered components; and combinations thereof.
